(19) United States
(12) Patent Application Publication
(10) Pub. No.: US 2003/0045598 A1
(43) Pub. Date: Mar. 6, 2003

(54) Radiation curable coating compositions

(75) Inventors: Mao Chen, Evansville, IN (US); Kang Xi, Terre Haute, IN (US); Kenneth Lee Lilly, West Chester, OH (US)

Correspondence Address: Hanh T. Pham, GE Plastics, One Plastics Avenue, Pittsfield, MA, 01201, US

(73) Assignee: General Electric Company

(21) Appl. No.: 09/990,721

(22) Filed: Nov. 14, 2001

Related U.S. Application Data
(60) Provisional application No. 60/308,927, filed on Jul. 31, 2001.

(51) Int. Cl. C08K 3/36; C08K 3/00; C08F 2/46; C08J 3/28; C09D 183/04

(52) U.S. Cl. 522/83; 522/74; 522/96; 522/103; 522/107; 522/99

(57) ABSTRACT

A radiation curable coating composition includes a mixture of an oligomeric acrylate having a crosslinkable acrylate functionality of 1 to 6, at least one of monomeric acrylates and dimeric acrylates, having a crosslinkable acrylate functionality of 1 to 6, an acrylated colloidal silica, and a photoinitiator.

### CROSS REFERENCE TO RELATED APPLICATIONS

This application claims priority to U.S. Provisional Application Serial No. 60/308,927 filed on Jul. 31, 2001, which is incorporated herein by reference in its entirety.

### BACKGROUND OF THE INVENTION

This invention relates generally to radiation curable coating compositions, and more particularly, to radiation curable coating compositions that provide high abrasion resistance, chemical resistance, flexibility, and low birefringence when applied to plastic films or plastic sheet.

Plastic substrates have become increasingly popular for many uses, for example optical storage cards, immigration cards, “smartcards”, and formable plastic sheets which can be formed into, for example, wind shield, goggles, lens, and displays. Because thermoplastic substrates typically lack sufficient hardness, they have a tendency to scratch in daily use, and usually require some kind of a protective coating for abrasion resistance. However, current abrasion coatings typically do not exhibit sufficient flexibility and stress resistance in applications where the plastic substrate is bent or formed. For example, stress in the plastic substrate coated with the abrasion resistant coating can cause laser signal attenuation during optical recording/reading in data storage applications.

### BRIEF DESCRIPTION OF THE INVENTION

In one embodiment, a radiation curable coating composition is provided. The coating composition includes a mixture of an oligomeric acrylate having a crosslinkable acrylate functionality of 1 to 6, at least one of a monomeric acrylate and a dimeric acrylate, having a crosslinkable acrylate functionality of 1 to 6, an acrylated colloidal silica, and a photoinitiator.

In another embodiment, a radiation curable coating composition is provided that includes a mixture of about 5 to about 50 parts by weight of an oligomeric acrylate having a crosslinkable acrylate functionality of 1 to 6, about 5 to about 80 parts by weight of at least one of monomeric acrylates and dimeric acrylates, having a crosslinkable acrylate functionality of 1 to 6, about 0.1 to about 75 parts by weight of an acrylated colloidal silica, and about 0.1 to about 10 parts by weight of a photoinitiator.

In another embodiment, a method of preparing a coated plastic substrate having abrasion resistance and low birefringence is provided. The method includes, supplying a plastic substrate of a plastic sheet or a plastic film, applying at least one layer of a radiation curable coating to at least one surface of the plastic substrate, and exposing the at least one layer of the radiation curable coating to a radiation source for a sufficient time to cure the coating and form a protective layer on the substrate. The radiation curable coating includes a mixture of 5 to about 50 parts by weight of an oligomeric acrylate having a crosslinkable acrylate functionality of 1 to 6, about 5 to about 80 parts by weight of at least one of monomeric acrylates and dimeric acrylates, having a crosslinkable acrylate functionality of 1 to 6, about 0.1 to about 75 parts by weight of an acrylated colloidal silica, and about 0.1 to about 10 parts by weight of a photoinitiator.

### DETAILED DESCRIPTION OF THE INVENTION

In an exemplary embodiment of the present invention, radiation curable coating compositions for use in plastic film and plastic sheet applications are provided. These radiation curable coating compositions provide abrasion resistance and chemical resistance to the plastic substrate while exhibiting high flexibility and low stress.

As used herein the expression “radiation curable” means cure resulting from actinic radiation such as ultraviolet (UV) light, or particle radiation such as an electron beam.

In one embodiment, the radiation curable coating composition includes a mixture of an oligomeric acrylate having a crosslinkable acrylate functionality of 1 to 6, at least one of monomeric acrylates and dimeric acrylates, having a crosslinkable acrylate functionality of 1 to 6, an acrylated colloidal silica, and a photoinitiator.

In one embodiment the radiation curable coating composition includes about 5 to about 50 parts by weight of the oligomeric acrylate, and in another embodiment, about 25 to about 35 parts by weight. Suitable oligomeric acrylates include, but are not limited to urethane modified acrylate oligomers, polyester modified acrylate oligomers, epoxy modified acrylate oligomers, silicone modified acrylate oligomers, and mixtures thereof. It should be understood that the term acrylate is meant to include the equivalent methacrylate. For example, oligomeric acrylates also includes oligomeric methacrylates. Oligomeric acrylates and methacrylates are commercially available from Sartomer, Inc., Sexton, Pa., and Fairad Technology, Inc., Morrisville, Pa.

In one embodiment, the radiation curable coating composition includes about 5 to about 80 parts by weight of monomeric acrylates and/or dimeric acrylates having a crosslinkable acylate functionality of 1 to 6. Suitable monomeric and dimeric acrylates include, but are not limited to cyclopentyl methacrylate, cyclohexyl methacrylate, methylcyclohexylmethacrylate, trimethylcyclohexyl methacrylate, norbornylmethacrylate, norbornylmethyl methacrylate, isobornyl methacrylate, lauryl methacrylate 2-ethylhexyl methacrylate, 2-hydroxyethyl methacrylate, hydroxypropyl acrylate, hexanediol acrylate, 2-phenoxyethyl acrylate, 2-hydroxyethyl acrylate, 2-hydoxypropyl acrylate, diethyleneglycol acrylate, hexanediol methacrylate, 2-phenoxyethyl methacrylate, 2-hydroxyethyl methacrylate, 2-hydoxypropyl methacrylate, diethyleneglycol methacrylate, ethylene glycol dimethacrylate, ethylene glycol diacrylate, propylene glycol dimethacrylate, propylene glycol diacrylate, allyl methacrylate, allyl acrylate, butanediol diacrylate, butanediol dimethacrylate, 1,6-hexanediol diacrylate, 1,6-hexanediol dimethacrylate, diethyleneglycol diacrylate, trimethylpropane triacrylate, pentaeryritol tetraacrylate, hexanediol dimethacrylate, diethyleneglycol dimethacrylate, trimethylolpropane triacrylate, trimethylpropane trimethacrylate, pentaeryritol tetramethacrylate, and mixtures thereof.

In one embodiment the radiation curable coating composition includes about 0.1 to about 75 parts by weight of the acrylated colloidal silica, and in another embodiment from about 25 to about 60 parts by weight. The term colloidal silica is intended to present a wide variety of finely divided SiO₂ forms which can be utilized to form the coating composition. The colloidal silica is acrylated by adding, for example, an alkoxysilylacrylate to a dispersion of colloidal silica in a water miscible C(3-5) branched alcohol, or a dispersion of colloidal silica in a water miscible straight chain alcohol having at least 20% by weight of a branched C(3-5) water miscible alcohol.

The radiation curable coating compositions can contain a photosensitizing amount of a photoinitiator, i.e., an amount effective to effect the photocure in air or an inert atmosphere, for example, nitrogen, of the coating composition. In one embodiment, this amount is from about 0.1 parts to about 10 parts by weight, and in another embodiment from about 0.5 parts to about 5 parts by weight of the coating composition.

Suitable photoinitiators include, but are not limited to benzophenone and other acetophenones, benzil, benzaldehyde and O-chlorobenzaldehyde, xanthone, thioxanthone, 2-chlorothioxanthone, 9,10-phenanthrenenquinone, 9,10-anthraquinone, methylbenzoin ether, ethylbenzoin ether, isopropyl benzoin ether, 1-hydroxycyclohexyphenyl ketone, α,α-diethoxyacetophenone, α,α-dimethoxyacetoophenone, 1-phenyl-,1,2-propanediol-2-o-benzoyl oxime, 2,4,6-trimethylbenzoyldiphenyl phosphine oxide, and, α,α-dimethoxy-α-phenylacetopheone. Photoinitiators with high intensity at tong wavelength region (>400 nm) permit sufficient cure even when the coating is cured by UV light passing through a UV absorbing substrate.

In one embodiment, the radiation curable coating composition can also include about 0.1 part to about 15 parts by weight of a UV absorber or stabilizer, and in another embodiment, about 1 part to about 10 parts by weight. Suitable UV stabilizers include, but are not limited to, resorcinol monobenzoate, 2-methyl resorcinol dibenzoate, 4,6-dibenzoyl resorcinol, silanated 4,6-dibenzoyl resorcinol, etc., benzophenones, benzotriazoles, cyanoacrylates, triazines, hindered amine stabilizers, and mixtures thereof.

The radiation curable coating composition can also include about 0.1 to about 80 parts by weight of a solvent. Suitable organic solvents include, but are not limited to, alcohols, for example, any water miscible alcohol, for example, methanol, ethanol, propanol, butanol, etc. or ether alcohols, such as ethoxyethanol, butoxyethanol, methoxypropanol, etc. and mixtures thereof.

The radiation curable coating composition can be applied to plastic film or plastic sheet stock by a variety of application processes such as dip coating, flow coating, roll coating, slide or curtain coating, blade coating, and spray coating, including electrostatic spray coating. The applied wet coating is then cured by exposure to UV light or electron beam radiation. In one embodiment, the coating is cured in a nonoxidizing atmosphere, such as in nitrogen. In another embodiment, an oxygen free curing environment is produced by feeding the coating into the gap between a cast roll and the substrate film in a roll coater. The coating is then cured by exposure to UV light passing through the substrate. Because tie coating is positioned between the cast roll and the plastic substrate, such as polycarbonate film, the coating is not exposed to oxygen during the cure, therefore the air is excluded.

The cured radiation curable coating provides excellent abrasion resistance, chemical resistance flexibility, and weatherability. Further the cured coating film exhibits low stress characteristics, and when used as a coating on a low stress plastic film or sheet produces a low stress or low birefringence composite substrate. The radiation curable coating composition can be applied to plastic sheet substrates or plastic film substrates having various surface finishes, for example, polished and/or textured. The coated plastic films and sheets can be used in the manufacture of, for example, optical storage cards, immigration cards, “smartcards”, and formable plastic sheets which can be formed into, for example, windshields, goggles, lens, and displays.

The invention will be further described by reference to the following examples which are presented for the purpose of illustration only and are not intended to limit the scope of the invention.

### EXAMPLES

Examples 1-16 show various formulations of radiation curable coating compositions in accordance with embodiments of the present invention. The coating compositions of Examples 1-16 were made by mixing the components together in a suitable container. Table 1 lists the components and parts by weight of each component for Examples 1-8, and Table 2 lists the components and parts by weight of each component for Examples 9-16. The coating compositions of Examples 1-16 were applied by a roll coater to thick clear polycabonate films (15 mil thickness) and cured by exposure to UV light in an oxygen free environment. The UV light was directed through the plastic substrate while the deposited wet coating film was positioned between the roll and the plastic substrate, thereby eliminating exposure of the coating to oxygen during the curing process. The dry film thickness of the coating was 5.0 micrometers. Flexibility was tested by a 180 degree bend around a 3/16 inch and a ¼ inch mandrel bar in accordance with ASTM D522 and D1737. An acceptable mandrel test result is no cracking at a mandrel diameter of 3/16 inch or greater for a 15 mil substrate. Abrasion resistance was measured on a Taber Abrader with a 500 gram and 100 cycles using CS-10F wheels in accordance with ASTM test method 4060-95. An acceptable Taber test result is a Taber haze rating of 5% or less. Examples 1-16 exhibited satisfactory flexibility and abrasion resistance.

TABLE 1

| | Ex 1 | Ex 2 | Ex 3 | Ex 4 | Ex 5 | Ex 6 | Ex 7 | Ex. 8 |
|---|---|---|---|---|---|---|---|---|
| Oligomeric diacrylate¹ | 30 | 35 | 33 | 47 | 33 | 28 | 53 | 33 |
| Acrylated Colloidal Silica² | 58 | 58 | 50 | 45 | 60 | 65 | 30 | 60 |
| Hexanediol Diacrylate³ | 10 | 5 | 15 | 6 | 5 | 5 | 15 | 5 |
| Photoinitiator⁴ | 2 | 2 | 2 | 2 | 2 | 2 | 2 | 2 |

¹Fairad 8210 a urethane modified acrylate oligomer commercially available from Fairad Technology, Inc.
²FCS-100 commercially available from General Electric Plastics.
³SR-238 commercially available from Sartomer, Inc.
⁴Darocur 4265 commercially available from Ciba-Geigy Corporation.

TABLE 2

| | | Ex. | | | Ex. | | | Ex. |
|---|---|---|---|---|---|---|---|---|
| | Ex 9 | 10 | Ex 11 | Ex 12 | 13 | Ex 14 | Ex 15 | 16 |
| Oligomeric diacrylate¹ | 15 | 10 5 | 42 | 30 | 33 | 52 | 33 | 23 |
| Acrylated Colloidal Silica² | 70 | 72 5 | 50 | 53 | 50 | 43 | 60 | 60 |
| Hexanediol Diacrylate³ | 13 | 15 | 6 | 15 | 15 | 5 | 5 | 15 |
| Photoinitiator⁴ | 2 | 2 | 2 | 2 | 2 | 2 | 2 | 2 |

¹Fairad 9567 a urethane modified acrylate oligomer commercially available from Fairad Technology, Inc.
²FCS-100 commercially available from General Electric Plastics.
³SR-238 commercially available from Sartomer, Inc.
⁴Darocur 4265 commercially available from Ciba-Geigy Corporation.

Examples 17-19 show various formulation is of radiation curable coating compositions in accordance with embodiments of the present invention. The coating compositions of Examples 17-19 were made by mixing the components together in a suitable container. Table 3 lists the components and parts by weight of each component. The coating compositions of Examples 17-19 were applied by flow coating on to clear polycabonate sheet substrates (125 mil thickness) and cured by exposure to UV light in an oxygen free environment. The dry film thickness of the coating was 5 micometers. Flexibility was tested by forming a preheated 2 inch by 10 inch sample against ½ inch radius and 1 inch radius mandrels. An acceptable mandrel test result is no cracking at a mandrel diameter of 1 inch or less. Abrasion resistance was measured on a Taber Abrader with a 500 gram and 100 cycles using CS-10F wheels in accordance with ASTM test method 4060-95. An acceptable Taber test result is a Taber haze rating of 5% or less. Chemical resistance was evaluated using a spot test that included continuously contacting a drop of methylethyl ketone with the coated polycarbonate substrates for 1 hour at 73° F. Acceptable chemical resistance test result is no discolor of hazing of the film after 1 hour. Examples 17-19 exhibited satisfactory flexibility, abrasion resistance, and chemical resistance.

TABLE 3

| | Example 17 | Example 18 | Example 19 |
|---|---|---|---|
| Oligomeric diacrylate¹ | 50 | 52 | 46 |
| Acrylated Colloidal Silica² | 36 | 28 | 42 |
| Hexanediol Diacrylate³ | 12 5 | 13 | 5 |
| Photoinitiator⁴ | 1 5 | 1 5 | 1 5 |
| Light stabilizer⁵ | 0 | 5 | 5 |
| Light stabilizer⁶ | 0 | 0 5 | 0 5 |
| Methoxy ether⁷ | 100 | 100 | 100 |

¹Fairad 8210 a urethane modified acrylate oligomer commercially available from Fairad Technology, Inc.
²FCS-100 commercially available from General Electric Plastics.
³SR-238 commercially available from Sartomer, Inc.
⁴Darocur 4265 commercially available from Ciba-Geigy Corporation.
⁵Silanated 2-allyl-4,6-dibenzoyl resourcinol UV stabilizer described in U.S. Pat. No. 5,679,820.
⁶Tinuvin 123 hindered amine light stabilizer commercially available from Ciba-Geigy Corporation.

While the invention has been described in terms of various specific embodiments, those skilled in the art will recognize that the invention can be practiced with modification within the spirit and scope of the claims.

What is claimed is:

1. A radiation curable coating composition comprising a mixture of:
an oligomeric acrylate having a crosslinkable acrylate functionality of 1 to 6;
at least one of monomeric acrylates and dimeric acrylates, having a crosslinkable acrylate functionality of 1 to 6;
an acrylated colloidal silica; and
a photoinitiator.

2. A radiation curable coating composition in accordance with claim 1 wherein said oligomeric acrylate comprises at least one of urethane modified acrylate oligomers, polyester modified acrylate oligomers, epoxy modified acrylate oligomers, and silicone modified acrylate oligomers.

3. A radiation curable coating composition in accordance with claim 1 wherein said oligomeric acrylate comprises about 5 to about 50 parts by weight of said coating composition.

4. A radiation curable coating composition in accordance with claim 3 wherein said oligomeric acrylate comprises about 25 to about 35 parts by weight of said coating composition.

5. A radiation curable coating composition in accordance with claim 1 further comprising about 0.1 to about 10 parts by weight of a photoinitiator.

6. A radiation curable coating composition in accordance with claim 1 wherein said photoinitiator comprises about 0.5 to about 5 parts by weight of said coating composition.

7. A radiation curable coating composition in accordance with claim 1 wherein said acrylated colloidal silica comprises about 0.1 to about 75 parts by weight of said coating composition.

8. A radiation curable coating composition in accordance with claim 7 wherein said acrylated colloidal silica comprises about 25 to about 60 parts by weight of said coating composition.

9. A radiation curable coating composition in accordance with claim 1 further comprising about 0.1 to about 15 parts by weight of a UV stabilizer.

10. A radiation curable coating composition in accordance with claim 9 wherein said UV stabilizer comprises about 1 to about 10 parts by weight of said coating composition.

11. A radiation curable coating composition in accordance with claim 1 wherein said at least one of monomeric acrylates and dimeric acrylates comprises about 5 to about 80 parts by weight of said coating composition.

12. A radiation curable coating composition in accordance with claim 11 wherein said at least one of monomeric acrylates and dimeric acrylates comprises about 10 to about 75 parts by freight of said coating composition.

13. A radiation curable coating(composition in accordance with claim 1 further comprising from about 0.1 to about 80 parts by weight of solvent.

14. A radiation curable coating composition comprising a mixture of:
about 5 to about 50 parts by weight of an oligomeric acrylate having a crosslinkable acrylate functionality of 1 to 6;
about 5 to about 80 parts by weight of at least one of monomeric acrylates and dimeric acrylates, having a crosslinkable acrylate functionality of 1 to 6;
about 0.1 to about 75 parts by weight of an acrylated colloidal silica; and
about 0.1 to about 10 parts by weight of a photoinitiator.

15. A radiation curable coating composition in accordance with claim 14 wherein said oligomeric acrylate comprises about 25 to about 35 parts by weight of said coating composition.

16. A radiation curable coating composition in accordance with claim 14 wherein said at least one of monomeric acrylates and dimeric acrylates comprises about 10 to about 75 parts by weight of said coating composition.

17. A radiation curable coating composition in accordance with claim 14 wherein said photoinitiator comprises about 0.5 to about 5 parts by weight of said coating composition.

18. A radiation curable coating composition in accordance with claim 14 wherein said oligomeric acrylate comprises at least one of urethane modified acrylate oligomers, polyester modified acrylate oligomers, epoxy modified acrylate oligomers, and silicone modified acrylate oligomers.

19. A radiation curable coating, composition in accordance with claim 14 further comprising about 0.1 to about 15 parts by weight of a UV stabilizer.

20. A radiation curable coating composition in accordance with claim 19 wherein said UV stabilizer comprises about 1 to about 10 parts by weight of said coating composition.

21. A radiation curable coating composition in accordance with claim 14 further comprising from about 0.1 to about 80 parts by weight of solvent.

22. A radiation curable coating composition in accordance with claim 14 wherein said acrylated colloidal silica comprises about 25 to about 60 parts by weight of said coating composition.

23. A method of preparing a coated plastic substrate having abrasion resistance and low birefringence, said method comprising:
supplying a plastic substrate comprising a plastic sheet or a plastic film;
applying at least one layer of a radiation curable coating to at least one surface of the plastic substrate; and
exposing the at least one layer of the radiation curable coating to a radiation source for a sufficient time to cure the coating and form a protective layer of the substrate, said radiation curable coating comprising a mixture of:
about 5 to about 50 parts by weight of an oligomeric acrylate having a crosslinkable acrylate functionality of 1 to 6;
about 5 to about 80 parts by weight of at least one of monomeric acrylates and dimeric acrylates, having a crosslinkable acrylate functionality of 1 to 6;
about 0.1 to about 75 parts by weight of an acrylated colloidal silica; and
about 0.1 to about 10 parts by weight of a photoinitiator.

24. A method in accordance with claim 23 wherein exposing the at least one layer of the radiation curable coating to a radiation source comprises exposing the at least one layer of the radiation curable coating to at least one of UV light and electron beam radiation.

25. A method with claim 23 wherein the oligomeric acrylate comprises about 25 to about 35 parts by weight of the coating composition.

26. A method in accordance with claim 23 wherein the at least one of monomeric acrylates and dimeric acrylates comprises about 10 to about 75 parts by weight of the coating composition.

27. A method in accordance with claim 23 wherein the photoinitiator comprises about 0.5 to about 5 parts by weight of the coating composition.

28. A method in accordance with claim 23 wherein the oligomeric acrylate comprises at least one of urethane modified acrylate oligomers, polyester modified acrylate oligomers, epoxy modified acrylate oligomers, and silicone modified acrylate oligomers.

29. A method in accordance with claim 23 further comprising about 0.1 to about 15 parts by weight of a UV stabilizer.

30. A method in accordance with claim 29 wherein the UV stabilizer comprises about 1 to about 10 parts by weight of said coating composition.

31. A method in accordance with claim 23 further comprising from about 0.1 to about 80 parts by weight of solvent.

32. A method in accordance with claim 23 wherein the acrylated colloidal silica comprises about 25 to about 60 parts by weight of the coating composition.
